(19) United States
(12) Patent Application Publication
(10) Pub. No.: US 2014/0176296 A1
(43) Pub. Date: Jun. 26, 2014

(54) METHODS AND SYSTEMS FOR MANAGING MOTION SICKNESS

(71) Applicant: HeadsUp Technologies, Inc., Needham, MA (US)

(72) Inventor: Edward James Morgan, Needham, MA (US)

(73) Assignee: HeadsUp Technologies, Inc., Needham, MA (US)

(21) Appl. No.: 14/135,072

(22) Filed: Dec. 19, 2013

Related U.S. Application Data
(60) Provisional application No. 61/739,227, filed on Dec. 19, 2012.
(60) Provisional application No. 61/804,800, filed on Mar. 25, 2013.
(60) Provisional application No. 61/865,460, filed on Aug. 13, 2013.
(60) Provisional application No. 61/872,980, filed on Sep. 3, 2013.
(60) Provisional application No. 61/872,985, filed on Sep. 3, 2013.

(51) Int. Cl. G06F 3/01

(52) U.S. Cl. CPC G06F 3/011
USPC 340/4.13

(57) ABSTRACT

Methods and systems are provided herein for reducing or eliminating motion sickness in users of devices, such as mobile devices, in a variety of environments, including methods and systems for sensing motion in the user's environment and providing feedback that encourages a user to orient in a motion-reducing manner.

### CROSS REFERENCE TO RELATED APPLICATIONS

This application is based upon and claims priority to U.S. Provisional Patent Application No. 61/739,227, filed Dec. 19, 2012; U.S. Provisional Patent Application No. 61/804,800, filed Mar. 25, 2013; U.S. Provisional Patent Application No. 61/865,460, filed Aug. 13, 2013; U.S. Provisional Patent Application No. 61/872,980, filed Sep. 3, 2013; and U.S. Provisional Patent Application No. 61/872,985, filed Sep. 3, 2013, the entire disclosure of each of which is hereby incorporated by reference.

### BACKGROUND

1. Field

The disclosure is related to a biofeedback system designed to induce balance behavior offsetting symptoms of motion sickness

2. Description of the Related Art

For thousands of years mankind has suffered from motion sickness. Every since man first started traveling by animal and boat, the human balance system has struggled to adapt to motion it had not evolved to understand. Today, 30-50% of all adults suffer from motion sickness when traveling via land, sea or air. The numbers are even higher among children and the elderly. Few sound scientific solutions have existed to address the condition of motion sickness and its impact is felt from casual activities all the way to mission critical life risking situation. The average individual may suffer nausea when traveling on a boat, reading in a car, playing video games or even just sitting backwards on a train. Most afflicted people have learned to deal with this ailment by trying to avoid those life situations. But other scenarios are less optional. The medical profession has long tried to address the motion sickness that patients experience when riding in the back of an ambulance. Cruise ship operators struggle to deal with hoards of sick passengers during poor weather. Crane operators have been known to cause major accidents while experiencing nausea after long periods at the controls. The FAA has a special program to help pilots understand motion sickness in flight as well as in flight simulators. And the military has found that almost half the troops traveling in large transport planes get sick during long flights. In fact, the military and NASA have invested the most time and money attempting to understand the causes of motion sickness due the debilitating effects the phenomenon causes during combat situations and space travel.

Very little is known about the true underlying causes of motion sickness but due to a great deal of research in the past three decades, we are beginning to understand more and more about how the human body reacts to motion. The human brain monitors information it collects from the visual vestibular system consisting of three different senses: the vestibular system in the ear, the eyes and the muscular system. The brain uses all this data to determine which direction is up and to keep a person from falling down. We have evolved over time to be able to maintain visual focus on an object while running or turning but the system seems to break down when unnatural forms of motion are introduced. Basically, the human brain isn't born with the ability to handle the pattern of sensory inputs it receives when traveling at 60 miles per hour or heaving in 20 foot ocean swells. In fact, research suggests that even the balance needed for standing and walking is a learned behavior during childhood. This learning explains why individuals can develop their “sea legs” after several days at sea. The brain over time figures out the patterns of data it is receiving from the visual vestibular system. But we don't know why some people adapt more easily than others, why some people get worse, and why some motion situations are extremely difficult to adapt to.

NASA researchers during the 1970s were attempting to address “space sickness” that most astronauts experience in zero gravity. Millard Reschke of NASA posited that motion sickness was caused by something known as “retinal slip”. The brain's interpretation of what is was seeing was not fast enough to match what it was feeling. That disconnect for a still unknown reason induces nausea. To test this theory Reschke utilized strobe light techniques to slow down what individual were seeing inside space capsules. He also patented strobe goggles for applications in other user scenarios, Motion Sickness Treatment Apparatus and Method U.S. Pat. No. 6,932,090.

During the 1980s another school of thought began to develop after researchers at the University and Minnesota and elsewhere began investigating the causes of simulator sickness. Many pilots when training in flight simulators will get nauseous. The researchers also began to observe individuals getting nauseous when playing video games. One study by Professor Thomas Stoffregen of the University of Minnesota showed that game players who leaned their body along with the motion of the game were less likely to experience symptoms than those that did not adjust their body posture (Riccio & Stoffregen, 1991). Stoffregen has also found that ocean travelers who exhibit more postural sway prior to embarking are more likely to suffer from sea sickness during the trip. Part of the body orientation hypothesis derives from observing how the driver of a car tends to lean into turns and movement while passengers do the opposite. And drivers rarely complain of motion sickness. Why is the driver rarely motion sick? The role of controllability in motion sickness. Rolnick A, Lubow R E. 1991 July; 34(7):867-79. The authors believed the driver leaned in anticipation of the movement and that the control over the movement of the body orientation is what alleviated motion sickness.

There have been many attempts to feed motion data to users via audio and video with the expectation that additional data will help prevent motion sickness very similar to looking at the horizon while on a boat. Some examples are Apparatus and method for relieving motion sickness U.S. Pat. No. 6,228,021 and Apparatus and method for relieving motion sickness U.S. Pat. No. 6,042,533. All these prior efforts assume that just supplying the user with spatial data will allow them to bridge the disconnect in the balance sensory system. None of the prior disclosures include orientation guides to influence the user's head and body orientation. None of the disclosures monitor the spatial orientation of the user's head, they focus entirely on the movements and orientation of the vehicle or surroundings. This disclosure focuses on the connection between head orientation and motion sickness with a series of guides that essentially force the user to maintain consistent head orientation versus the gravito-inertial forces they are experiencing. With this technique, the forces that the vestibular system and the postural system experience will match what the visual system is telling the brain. There is no need for the user's brain to learn new data patterns and the results are instantaneous rather than learned over time.

### SUMMARY

Head balance is a key element of motion sickness relief. The disclosure describes a biofeedback system to guide a user to maintain consistent head orientation in motion situations in order to delay or eliminate the onset of motion sickness symptoms. Through a multi-step process of monitoring, assessing, delivering and guiding, the system continuously feeds information to the user. Through a series of embodiments the system monitors the movement and spatial orientation of the subject's environment and the subject's head in real time as well as the collection of a panel of physiological input data to determine how well the subject is maintaining his or her head balance and to what degree the subject is experiencing symptoms of motion sickness. The system analyzes all the input data and calculates in real time what alterations in head orientation are required to maintain balance against the gravito-inertial forces the head is experiencing. The system also computes the level of symptoms the subject is experiencing and modifies the alteration calculations to adjust for how the subject is responding to the system. The system then determines what is the best delivery mechanism for the orientation guides based on the network topology and device configuration to provide the feedback in the least obtrusive and adaptable means possible. Once the feedback mechanism is determined the system produces the feedback guide to convey the balance guidance to the subject. This entire cycle of input assessment and output guides is repeated many times per second.

Methods and systems are provided herein for reducing motion sickness of a user, such as a reader. Such methods and systems may include a device having a processor and a display for displaying content to a user; a detection facility for detecting at least one of location, orientation, motion and acceleration of the device; and a display modification module for modifying the content to induce the user to move in coordination with the detection. In embodiments, modifying the content comprises adjusting at least one of the vertical and horizontal positions of the display. In embodiments modifying the content comprises adjusting the content position relative to the direction of gravity and inertial forces. In embodiments modifying content comprises sliding the content on the display in the opposite direction of the pull of the gravito-inertial force as a vehicle turns.

Methods and systems for reducing motion sickness of a user as disclosed herein may include a device having a processor and a display for displaying content to a user; a detection facility of the device for detecting at least one of location, orientation, motion and acceleration of the device; and a display modification module for modifying the content to induce the user to move in coordination with the detection.

Methods and systems for reducing motion sickness of a user as disclosed herein may include a device having a processor and a display for displaying content to a user; at least one sensor external to the device for detecting at least one of motion and acceleration of the environment in which the device is located; and a display modification module for modifying the content, based on the detected motion or acceleration, to induce the user to move in coordination with the motion of the environment of the device. In embodiments the environment is a vehicle. In embodiments the external sensor is associated with a vehicle.

Methods and systems for reducing motion sickness of a user as disclosed herein may include a device having a processor and a display for displaying content to a user; at least one motion sensor for detecting motion of the environment in which the device is located; and a processing module external to the device for determining a modification to the content display based on the detected motion to induce the user to move in coordination with the motion. In embodiments such methods and systems may further include modifying the display of content based on the determined modification.

Methods and systems for reducing motion sickness of a user as disclosed herein may include a device having a processor and a display for displaying content to a user; at least one motion sensor for detecting the intensity and direction of a turn of a vehicle in which the device is located; and a processing module determining a modification to the content display based on the detected intensity and direction of the turn to induce the user to tilt the user's head in coordination with the direction and intensity of the turn. Such methods and systems may further include modifying the display of content based on the determined modification.

Methods and systems for reducing motion sickness of a user as disclosed herein may include a device having a processor and a display for displaying content to a user; at least one system for predicting at least one of the intensity and direction of at least one of motion and acceleration of a vehicle in which the device is located; and a processing module determining a modification to the content display based on the prediction to induce the user to adjust at least one posture in coordination with the motion or acceleration.

In embodiments prediction of at least one of intensity and direction of at least one of motion and acceleration is based on at least one of GPS data, accelerometer information, compass information, gyro information, information from a vehicle steering system, information from a braking system, information from a gas pedal, information from a vehicle-mounted camera, information from a device-mounted camera, information from a head-worn device, and information from a vehicle's engine control unit.

Methods and systems for reducing motion sickness of a user as disclosed herein may include a device having a processor and a display for displaying content to a user; a motion detection facility for detecting motion of the device; and a display modification module for modifying the content to induce the user to move in coordination with the motion of the device, wherein the content modification comprises providing a strobe effect for the content.

In embodiments providing a strobe effect comprises modifying the intensity of at least one of an LED and an LCD screen feature of the content display at a frequency adapted to reduce retinal slip.

Methods and systems for reducing motion sickness of a user as disclosed herein may include a device having a processor and a display for displaying content to a user; a detection facility for detecting at least one of location, orientation, motion and acceleration of the device; and a display modification module for modifying the content to induce the user to move in coordination with the detection, wherein modifying the content comprises bending the content on the display to make the text appear to be leaning at least one of away from the user and toward the user based on the detected location, orientation, motion or acceleration.

Methods and systems for reducing motion sickness of a user as disclosed herein may include a device having a processor and a display for displaying content to a user; a detection facility for detecting at least one of location, orientation, motion and acceleration of the device; and a display modification module for modifying the content to induce the user to move in coordination with the detection, wherein modifying the content comprises scrolling the content in response to the detected location, orientation, motion or acceleration to induce the user to lean in order to diminish the effects of pitch motion.

Methods and systems for reducing motion sickness of a user as disclosed herein may include a device having a processor and a display for displaying content to a user; an environment identification facility for identifying the type of environment in which the device is located; a detection facility for detecting at least one of location, orientation, motion and acceleration of the device; and a display modification module for modifying the content to induce the user to move in coordination with the detected location, motion, orientation or acceleration of the device, wherein the content modification is based on a motion pattern that is typical for the identified type of environment.

In embodiments the environment of the device comprises at least one of a car, a bus, a train, a spaceship, a walking environment, a boat, a ship, an airplane, a helicopter, a flying environment, a floating environment, a trolley car, and a subway car.

Methods and systems for reducing motion sickness of a user as disclosed herein may include a device having a processor and a display for displaying content to a user; a detection facility for detecting at least one of location, orientation, motion and acceleration of the device; and a display modification module for modifying the content to induce the user to move in coordination with the detection, wherein modifying content is based on determining motion of the environment of the device based on a weighting of the outputs of at least two inputs.

In embodiments motion the inputs are selected from the group consisting of at least one accelerometer, at least one pitch sensor, at least one roll sensor, at least one yaw sensor, at least one GPS input, at least one compass, at least one gyroscope, at least one magnetometer, at least one camera, at least one Bluetooth-connected device, at least one WiFi-connected device, and at least one proximity sensor.

Methods and systems for reducing motion sickness of a user as disclosed herein may include a device having a processor and a display for displaying content to a user; a detection facility for detecting at least one of location, orientation, motion and acceleration of the device; and a display modification module for modifying the content to induce the user to move in coordination with the detection, wherein modifying content is based on determining a change in motion of the environment based on a change in the output of at least one sensor.

In embodiments the sensor is selected from the group consisting of at least one accelerometer, a pitch sensor, a roll sensor, a yaw sensor, at least one GPS input, at least one compass, at least one gyroscope, at least one magnetometer, at least one camera, at least one Bluetooth-connected device, at least one WiFi-connected device, and at least one proximity sensor.

Methods and systems for reducing motion sickness of a user as disclosed herein may include a wearable device having a processor and a display for displaying content to a user; a detection facility for detecting at least one of location, orientation, motion and acceleration of the device; and a display modification module for modifying the content to induce the user to move in coordination with the detection.

Methods and systems for reducing motion sickness of a user as disclosed herein may include: a device having a processor and a display for displaying content to a user; a detection facility for detecting at least one of location, orientation, motion and acceleration of the device; and a display modification module for modifying the content to induce the user to move in coordination with the detection, wherein modifying content includes providing a visual representation of a gyro to assist the user in maintaining orientation.

Methods and systems for reducing motion sickness of a user as disclosed herein may include a device having a processor and a display for displaying content to a user; a detection facility for detecting at least one of location, orientation, motion and acceleration of the device; and a display modification module for modifying the content to induce the user to move in coordination with the detection, wherein modifying content includes providing a visual representation of a virtual horizon to assist the user in maintaining orientation.

Methods and systems for reducing motion sickness of a user as disclosed herein may include a device having a processor and a display for displaying content to a user; a detection facility for detecting at least one of location, orientation, motion and acceleration of the device; and a display modification module for modifying the content to induce the user to move in coordination with the detection, wherein modifying content includes providing scroll bars to assist the user in maintaining orientation.

Methods and systems for reducing motion sickness of a user as disclosed herein may include a device having a processor and a display for displaying content to a user; a detection facility for detecting at least one of location, orientation, motion and acceleration of the device; and a display modification module for modifying the content to induce the user to move in coordination with the detection, wherein modifying content includes providing shading to prompt the user to adjust orientation.

Methods and systems for reducing motion sickness of a user as disclosed herein may include a device having a processor and a display for displaying content to a user; a detection facility for detecting at least one of location, orientation, motion and acceleration of the device; a display modification module for modifying the content to induce the user to move in coordination with the detection; and a sound system for providing audible feedback to prompt the user to adjust orientation.

In embodiments modifying the content comprises adjusting at least one of the vertical and horizontal position of the display.

In embodiments modifying the content comprises adjusting the content position relative to the direction of gravity.

In embodiments modifying content comprises sliding the content on the display in the opposite direction of the pull of gravitational and inertial forces as a vehicle turns.

In embodiments modifying the content comprises strobing the content.

In embodiments strobing the content comprises modifying the intensity of at least one of an LED and an LCD screen feature of the content display at a frequency adapted to reduce retinal slip.

In embodiments modifying the content comprises scrolling the content in response to the detected location, orientation, motion or acceleration to induce the user to lean in order to diminish the effects of pitch motion.

In embodiments modifying the content comprises bending the content on the display to make the text appear to be leaning at least one of away from the user and toward the user based on the detected location, orientation, motion or acceleration.

In embodiments modifying the content comprises adjusting the content based on the typical frequency and intensity of motion of the type of environment in which the device is located.

In embodiments modifying content is based on determining motion of the environment of the device based on a weighting of the outputs of at least two inputs.

In embodiments modifying content includes providing a visual representation of a gyro to assist the user in maintaining orientation.

In embodiments modifying content includes providing a visual representation of a virtual horizon to assist the user in maintaining orientation.

In embodiments modifying content includes providing scroll bars to assist the user in maintaining orientation.

In embodiments modifying content includes providing shading to prompt the user to adjust orientation.

In embodiments methods and systems disclosed herein may further include providing audible feedback to prompt the user to adjust orientation.

In embodiments motion is detected using at least one of an accelerometer, a pitch sensor, a roll sensor, a yaw sensor, a GPS, a compass, a gyroscope, a magnetometer, a camera, a Bluetooth-connected device, a WiFi-connected device, a 3D angle measurement system, a rotation matrix, a rotation sensor, a course indicator, an altitude detector, a speed detector, a heading indicator, an infrared detector, a radar detector, an acoustic sensor, a sonar detector and a proximity sensor.

In embodiments the adjustment of posture is at least one of a head tilt and a lean of the body.

In embodiments prediction of at least one of intensity and direction of at least one of motion and acceleration is based on at least one of GPS data, accelerometer information, pitch information, roll information, yaw information, compass information, gyro information, information from a vehicle steering system, information from a braking system, information from a gas pedal, information from a vehicle-mounted camera, information from a device-mounted camera, information from a head-worn device, and information from a vehicle's engine control unit.

In embodiments the environment of the device comprises at least one of a car, a bus, a train, a spaceship, a walking environment, a boat, a ship, an airplane, a helicopter, a flying environment, a floating environment, a trolley car, and a subway car.

In embodiments the device is at least one of a smart glasses device, a cellphone, a smart phone, a tablet computer, a laptop computer, a smart watch, and a wearable device.

The disclosure and the following detailed description of certain embodiments thereof may be understood by reference to the following figures:

### BRIEF DESCRIPTION OF THE FIGURES

The disclosure and the following detailed description of certain embodiments thereof may be understood by reference to the following figures:

FIG. 1 depicts basic concept behind proper head orientation for motion sickness prevention

FIG. 2 depicts the entire system

FIG. 3 depicts the process and data flow of information through the system in an iterative model.

FIG. 4 depicts a high level view of the overall system.

FIG. 5 depicts an embodiment of the physical motion data the system collects from the device.

FIG. 6 depicts a high level schematic of a visual data module.

FIG. 7 depicts a high level schematic of an audible data module.

FIG. 8 depicts the physiological data subsystem that encompasses a number of data collection components.

FIG. 9 depicts the central motion system.

FIG. 10 lists out examples of the various hardware and network configuration options for the system

FIGS. 11-20 depict the orientation guides that the central motion system utilizes to deliver the optimal biofeedback data for the particular use case and device configuration.

FIG. 12 depicts a feedback model utilizing the strobing technique in order to alleviate retinal slip.

FIG. 13 depicts a visual orientation guide delivered via the screen of an e-reader, tablet, display or phone device.

FIG. 14 depicts a visual orientation guide delivered via the screen of an e-reader, tablet, display or phone device.

FIG. 15 depicts a visual orientation guide delivered via the screen of an e-reader, tablet, display or phone device.

FIG. 16 depicts a device configuration consisting of a wearable technology such as goggles or glasses with a heads-up display.

FIG. 17 depicts a device configuration consisting of a wearable technology such as an immersive virtual reality headset FIG. 18 depicts a device configuration built into a vehicle such as a car.

FIG. 19 depicts a number of configuration options that produce feedback via audio rather than visual guides.

FIG. 20 depicts device configurations for physical feedback mechanisms.

FIG. 21 depicts a physical configuration of the system in which the display itself rotates and tilts to guide the user to optimal head orientation.

FIG. 22 depicts various use cases and motion types.

### DETAILED DESCRIPTION

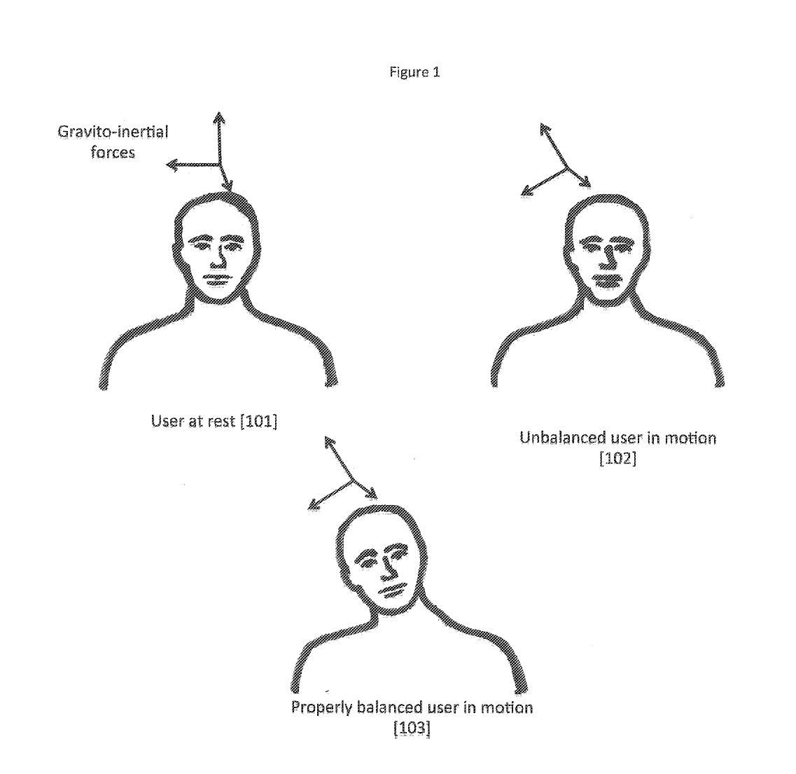

FIG. 1 depicts the concept of head orientation in more detail. The human balance system continuously monitors the information coming from the eyes, the ears and the muscles of the body. As the body moves the brain attempts to determine which way is up to help a person maintain his or her balance 101. In most situations this is an easy task built on behavior learned since childhood. But in many motion situations, the brain observes input data patterns that it has not adapted to and it becomes confused causing motion sickness. Based on data from the ears and postural system, the brain can assess the gravito-inertial forces present but in a car or boat, but those senses don't match what the eyes are seeing 102. The disclosure describes methods and systems to guide or force the user to lean his or her head to the exact orientation matching the current gravito-inertial forces thus bringing the sensory inputs into harmony and alleviating motion sickness caused by sensory confusion 103. These orientation changes can occur on any axis including roll, pitch, yaw, horizontal, vertical and depth.

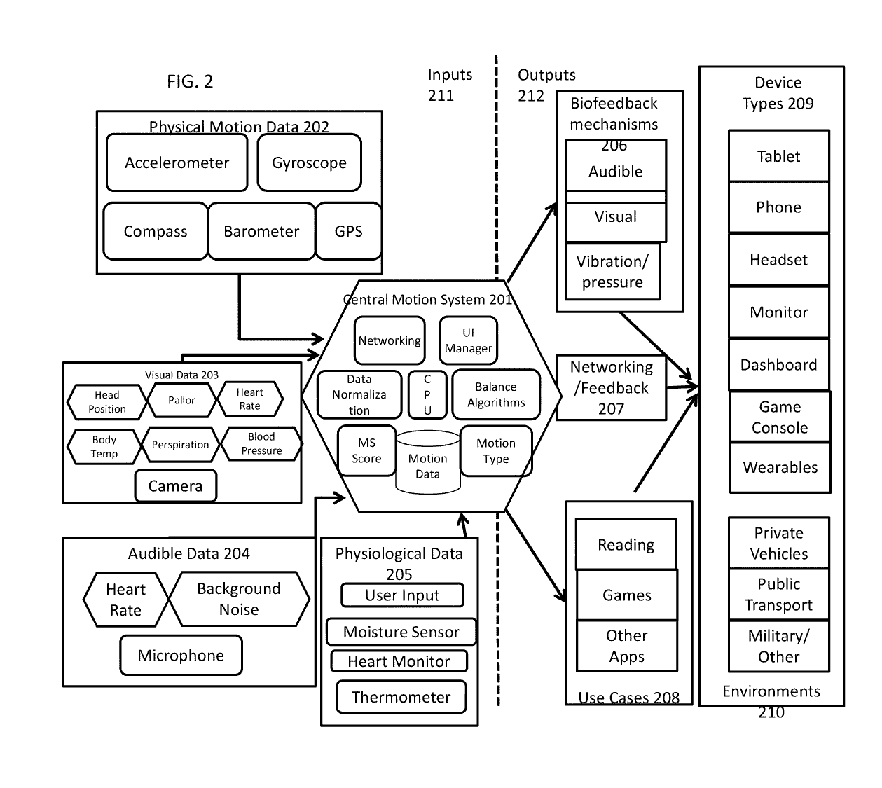

FIG. 2 depicts an overall system for managing motion sickness, as well as certain optional modules, components, devices, structures, and processes related to such a system. The system is comprised of a central motion system 201 handling most of the controlling logic. The central motion system optionally takes a wide range of inputs in order to produce an output that is adapted to guide or prompt a user in a manner that reduces motion sickness, usually by providing content or managing a stimulus on a user device. The central motion system, which may be integrated on a single device or consist of a set of distributed modules, may interface with the user, the user's environment, and other systems located in or connected to the environment in an ongoing, iterative fashion collecting data about the user, the device, the environment and other systems and producing output biofeedback to guide the user in the optimal manner to alleviate or moderate motion sickness. The various subsystems and configurations of FIG. 2 are generally divided into data inputs 211 on one side and outputs 212 on the other; however, it should be understood that output may in part be based on feedback, such that devices, environments and applications depicted on the right side of FIG. 2 can also provide input, such as in iterative and/or feedback loops. Not every embodiment of the system will include all input subsystems and/or output feedback configurations; that is, such subsystems and configurations may be provided in a wide range of optional combinations, all of which are intended to be encompassed by this disclosure. Most embodiments operate with the central motion system that optionally contains a central CPU and data storage, or a set of related modules that are physically separated but operate in a coordinated fashion to provide the handling described herein. Depending on the device configuration the central motion system may collect physical motion data 202, visual data (e.g., of the user or the environment) 203, audible data 204, user input data, data from other systems in or associated with the environment of the user or the device, and physiological data 205. Input data subsystems optionally contain a hardware component that monitors the motion situation (e.g., accelerometer, gyro, compass, GPS, etc.) for raw data collection and/or may contain one or more software modules that interpret the raw data and convert that data to motion or positional data, which may be fed to the central motion system. For example, the visual data subsystem may collect video of the user while the user operates the device using a camera hardware component. That video is processed in real time to interpret, for example, the user's head orientation, heart rate, skin color and other physiological attributes. Not only can each hardware component sense and produce a variety of motion sickness attributes, different hardware components can be utilized to produce the same attribute. For example either the camera or the microphone, or both, can be used to calculate a user's heart rate. Those two independent calculations can optionally be combined to produce a more accurate overall assessment of heart rate by the central motion system.

In embodiments, the system includes a catalog or library of various potential device configurations 209, display configurations, network topologies 207, use cases 208, environmental contexts, content types, motion types 210, and the like, so that the central motion system can select the optimal feedback guides 206 to present the user in order to achieve the desired physical response for a given situation, taking into account all of the above factors. Thus, the feedback models and algorithms used by the central motion system may change or be selected or adapted depending up on the input data described above and the particular use case at that time (factoring in all of the factors noted above). For example, reading a book requires concentration on each word in sequence, while playing a video game requires a user observe the entire screen, looking for changes to react to. A user listening to music has no display to observe and can only be guided via audible signals while a user wearing a motion sickness belt has neither display or speakers to guide the user and must rely on physical feedback, such as vibrations. A passenger on a boat in rough seas experiences very different motion patterns than someone riding the subway. The screen on a cockpit display has certain limitations during combat that a tablet screen is not limited by. All of these configuration and usage options may be taken into account by the central motion system, such as by selecting or adapting an appropriate algorithm for providing the right kind of output for the context, display type, content type, device type and the like of the user, based on the inputs (e.g., motion and user data) delivered to the central motion system. All such factors may be used in the central motion system as it produces the feedback guide necessary to alleviate motion sickness. FIG. 2 depicts many of these output configuration options and feedback models. The central motion system optionally collects the input data continuously, such as many times a second, makes decisions about the best corrective information to supply to the user, then constructs the optimal guidance or prompts for the situation and delivers it to the user. This process happens continuously while the user operates the device. Additional details with respect to the systems and components of FIG. 2 are provided throughout this disclosure.

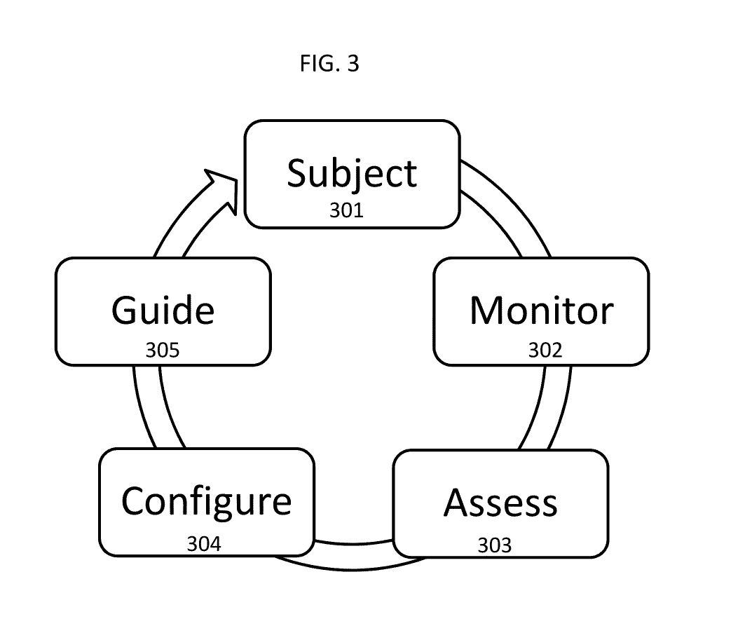

FIG. 3 depicts the process and data flow of information through the system in an iterative model. The user 301 utilizes the system during some form of motion whether it entails driving in a car, riding a train, flying in a plane, sitting on a boat or even traveling on a space ship. The system monitors 302 the movements of the device and of the user to determine the gravito-inertial forces that the user's vestibular system is experiencing at that moment. The system also monitors a series of input data to determine the degree of motion sickness symptoms that the user is experiencing. The system aggregates all the input data and assesses 303 what alterations the user needs to make to the head position in order to delay the onset of motion sickness and minimize any motion sickness symptoms. The system then determines how to configure 304 the proper feedback based on what device configurations are available to the system in order to properly guide the user to achieve the optimal physical response to the motion. Based on the chosen configuration the system produces the appropriate biofeedback guide 305 to the user. The process is repeated many times per second.

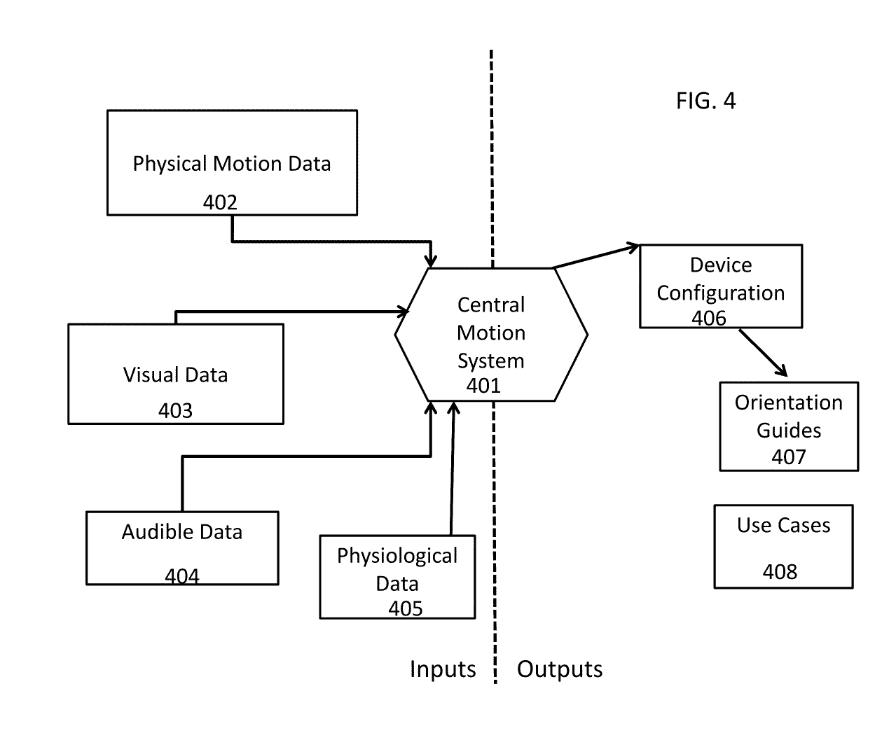

FIG. 4 describes a high level view of the overall system. The central motion system 401 contains the main logic of the system and processes all the input data and produces the output feedback guides. The input data includes not only sensors tracking the movement of the device or devices but also the movement of the user and more importantly the user's head. In addition the input data includes information physiological information about the degrees of motion sickness the user may be experiencing at that particular time. The physical motion data 402 contains sensor data about location, position, motion and angle of orientation of the device configuration. Visual data 403 includes a series of calculated orientation and physiological data obtained by complex analyses of a continuous video stream of the user and the surroundings. The audible data 404 includes a series of calculated physiological and environmental data which feed into the overall determination of the level of motion sickness the user is experiencing. Physiological data 405 includes miscellaneous sensors, calculations and manual user feedback, which feed into the overall determination of motion sickness that the user is experiencing. The central motion system continuously collects data from all these sources to make it determination about the types of feedback to deliver to the user. After making the assessment about what feedback to provide the user the central motion system takes into the account the current device configurations available 406 and the current use case 408 to construct the appropriate orientation guide 407.

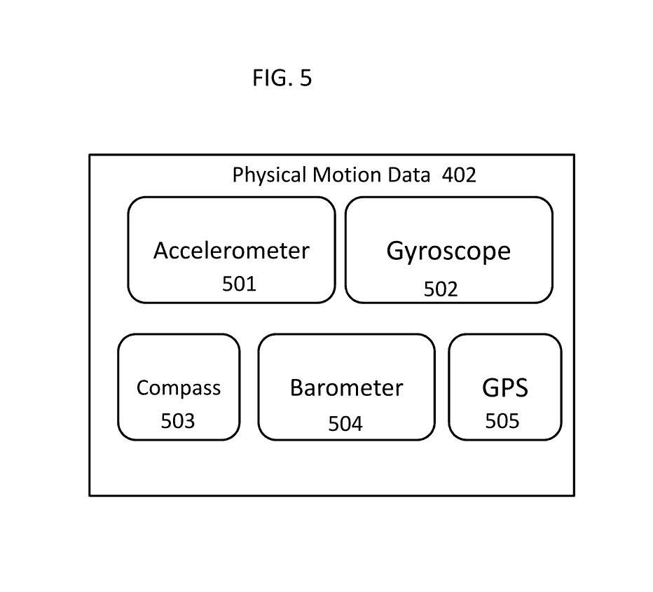

FIG. 5 depicts an embodiment of the physical motion data 402 the system collects from the device. Physical motion data 402 includes location, position, movement and angular data calculated by sensors that include a GPS 505, barometer 504, compass 503, accelerometer 501 and gyroscope 502. These sensors may be digital or analog but all feed data into the central motion system which is used to calculate the gravito-inertial forces present at that time and may include as well the head position of the user. The barometer calculates changes in altitude, the GPS measure location and velocity and the compass measure direction. These sensors, for example, may indicate that the device is traveling at 65 miles per hour on a major highway 1 meter above the ground heading due East but turning left 10 degrees resulting in a gravito-inertial force of 3 degrees along the roll axis.

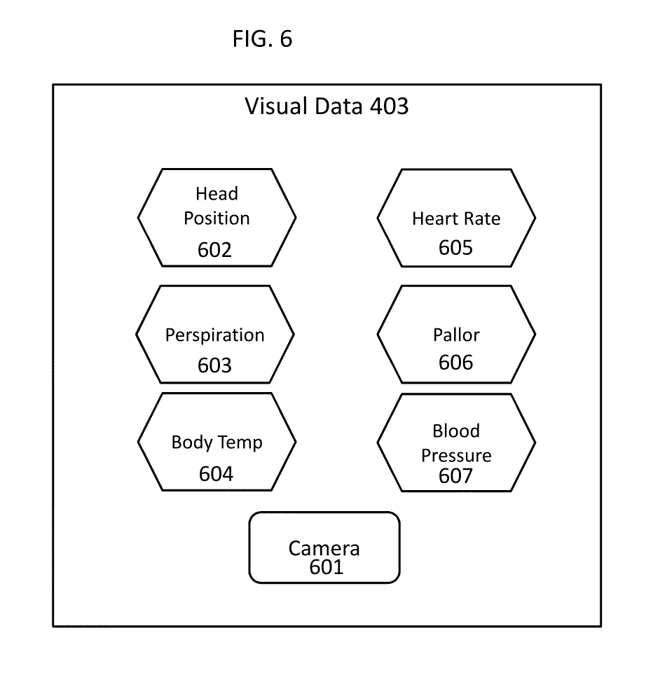

FIG. 6 depicts the module for the visual data 403. The module is a series of subsystems that calculate orientation and physiological data based on video input from a camera 601 of the user while operating the device. The first calculation the visual data module conducts is a determination of the user's head orientation relative to the device's motion sensors. Since the central motion system can calculate the device's orientation using the physical motion data module, the system merely needs to calculate the relative orientation of the user's head in order to assess the absolute orientation of the user's head position 602. Using computer vision logic, the module performs head pose estimation techniques to calculate the user's head angle and orientation along 6 different axes; roll, pitch, yaw, vertical, horizontal and depth. The central motion system can combine this data along with the device's orientation data to determine what adjustments the user's need to make in the head position in order to minimize motion sickness. The remaining subsystems of the visual data module are used to assess the physiological condition of the user due to the active motion. The perspiration subsystem 603 detects and monitors the skin color and brightness of the user's facial skin over time to assess whether any perspiration has formed on the skin. Increased sweating is one physiological indicator of the onset of motion sickness that the system tracks. The heart rate 605 subsystem monitors the user's facial skin color many times a second to capture the slight changes due to blood flow thru arteries in the skin. Those slight changes can be used to estimate the heart rate of the user over time. Increasing heart rate and heart rate variability have been shown in research studies to be an indicator of the onset of motion sickness symptoms.

Using the same skin color detection capabilities the visual data module uses the pallor subsystem 606 to continuously monitor the user's skin color. A lightening of skin color or pallor has been linked to symptoms of motion sickness. Researchers often track a subject's skin color to help measure the degree of motion sickness at any given time. The device's camera collects continuous video of the user and the pallor subsystem discerns changes in skin color over time. The body temperature subsystem 604 also uses the camera to monitor a user's body temperature over time since a measurable reduction is body temperature has been linked to the onset of motion sickness symptoms. There is also new research linking an increase in blood pressure as a result of the onset of motion sickness symptoms so the blood pressure subsystem 607 uses advanced computer vision techniques to monitor the user's blood pressure levels over time while using the device.

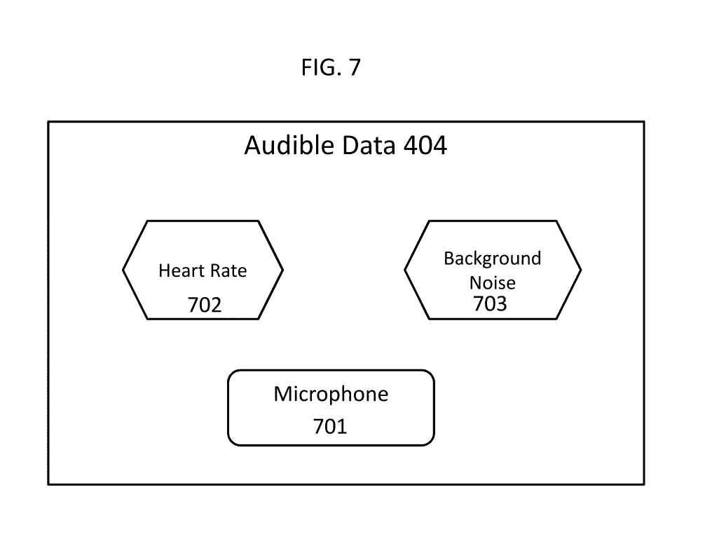

FIG. 7 depicts a module for the audible data 404 that utilizes the microphone 701 in the device to collect physiological data on the user to monitor motion sickness symptoms. The heart rate subsystem 702 utilizes new techniques of turning the speakers in earbuds and headphones into microphones that collect audio and pressure data from the inside and around the user's ears. Researchers at The Kaiteki Institute Inc. have demonstrated how to convert the changes in pressure in the enclosed space of the ear canal into heart rate measurements. The central motion system collects this heart rate data since changes in heart rate have been linked to the onset of motion sickness symptoms. The microphone is also used to collect levels of background noise while the user is operating the device. Motion symptoms intensify in busy noisy environments due to the distractions that caused while the brain is attempting to manage balance data. The background noise subsystem 703 monitors the noise level data and feeds it to the central motion system.

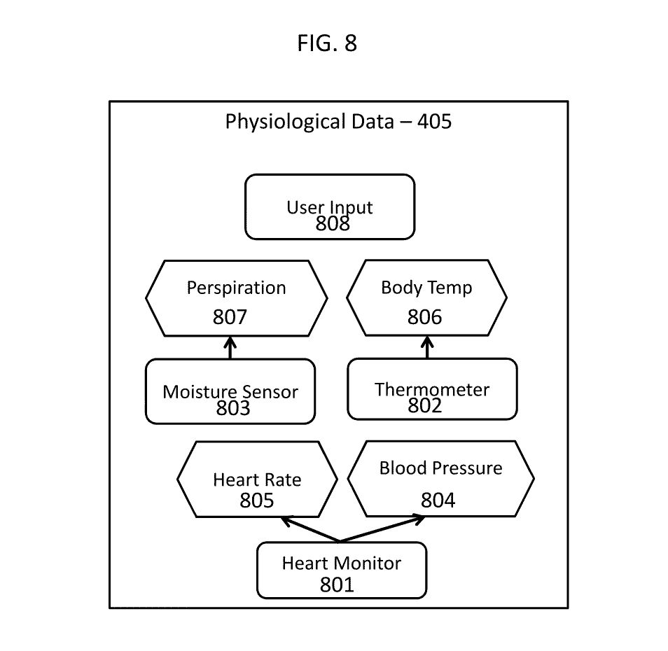

FIG. 8 depicts a subsystem for the physiological data 405. The subsystem encompasses a number of data collection components that monitor the health of the user in order to determine the user's level of motion sickness over time and feed that to the central motion system so that changes can be made to the biofeedback guides presented to the user. The heart monitor 801 is a physical apparatus that is worn by the user to measure heart rate 805 and blood pressure 804. These can take the form of chest bands, wristbands, arm cuffs and finger clamps. Changes in heart rate have been shown to indicate an increase in motion sickness symptoms so this data is fed to the central motion system for analysis. The moisture sensor 803 is a physical device worn by the user that measure levels of moisture on the user's hands or face. This data is fed to the perspiration subsystem 807 that calculates the changes in the user's level of perspiration which has been shown to be an indication of the increase in motion sickness symptoms. The thermometer 802 is a physical apparatus worn by the user that feeds temperature information to the body temperature subsystem 806 to calculate changes in the user's body temperature over time. The user may also be asked a series of questions about how they feel and what physical changes they may experiencing so that the subsystem can develop a qualitative measure 808 of the current motion sickness level. Questions could include whether they are experiencing any nausea, whether they have a headache, are sweating or feeling dizzy. The entire set of physiological data is then fed to the central motion system as another indication of the onset of motion sickness.

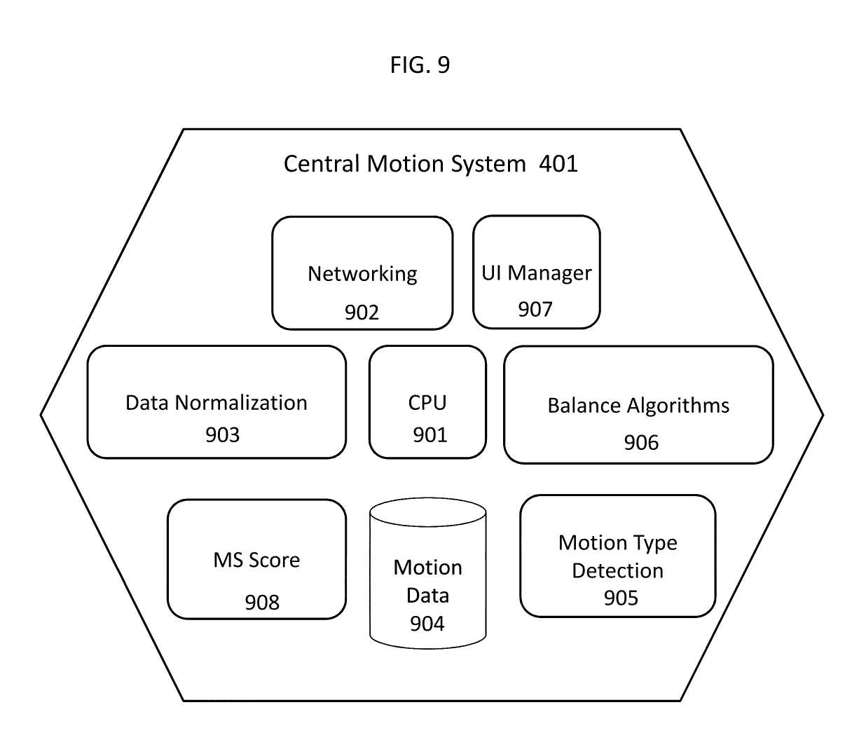

FIG. 9 depicts the central motion system 401, which is the core module of the disclosure. The central motion system includes a CPU 901 for processing all the motion input data, calculating the appropriate user response, then constructing the biofeedback guide to be delivered to the user. The networking module 902 determines the device configuration, the input sensors and data available and then makes the appropriate wired and wireless connections. The data normalization module 903 gathers all the input sensor data from all the input sensors and subsystems, then normalizes the data based on the current use case, environment and device configuration. That normalized data is stored in the central motion system's motion database 904. The real time motion data is analyzed by the motion type detection module 905 to determine whether the user is traveling via car, boat, plane, or spaceship, or not in motion at all. Once the motion type has been determined, the balance algorithms 906 then analyze the motion data from the input sensors to calculate the changes in head position required for the user to maintain steady balance versus the gravito-inertial forces the user is experiencing at that moment or will be anticipating in the immediate future. Based on the device configuration and the optimal feedback mechanism, the balance algorithms feed its motion adjustment guidance to the UI manager 907. The UI manager constructs the optimal visual, audible or physical feedback for the motion situation, the use case and the device configuration. While the real time assessment of the optimal head orientation continues in order to provide the optimal user feedback, the MS Score module 908 assesses how well the user is following the guides and what levels of symptoms they are exhibiting. With this information, the MS Score module calculates a quantitative score based on a variety of input factors. The MS Score is then used by the balance algorithms to make modifications in the feedback guides as well as to alert the user to the emergence of motion sickness possibly before they even feel it. An example alteration based on the MS Score may include changing the font size of the text on the display to reduce eyestrain for a user that continues to experience motion sickness symptoms even though following the guides appropriately.

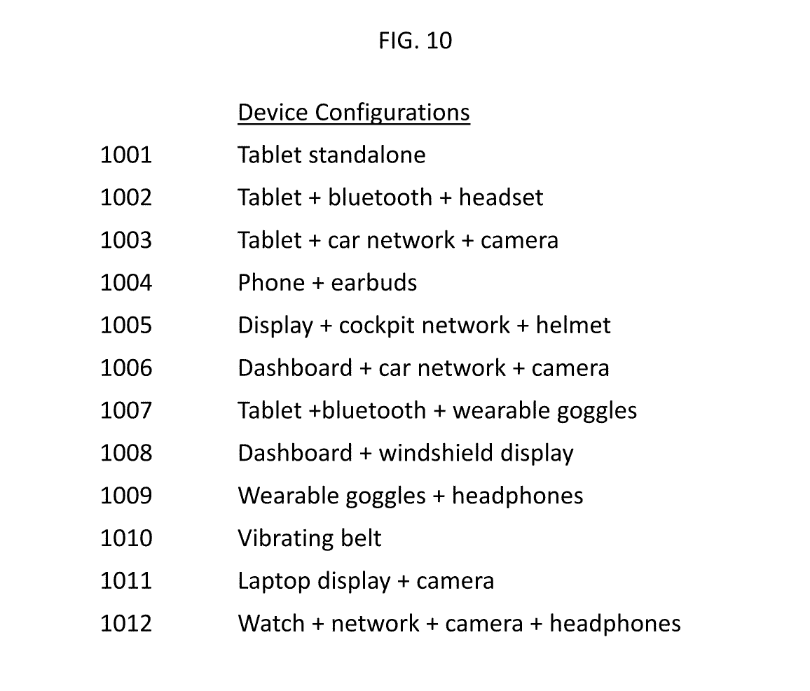

After determining the appropriate corrective motion response to be delivered to the user, the Central Motion System determines the proper feedback mechanism based on the device configuration and the particular use case 407. FIG. 10 lists out some embodiments of the variety of device configurations for the system. In some cases the entire system may reside on a single device 1001 or in other cases the system may be separated over a local area network as in items 1002, 1003. In item 1002, the tablet may contain the central motion system, the camera and the microphone while the headset may contain the physical motion sensors to detect the position of the head versus the motion forces. The sensor data from the headset may be communicated to the central motion system on the tablet via a direct wired, Bluetooth, Wi-Fi or cellular connection. In item 1003 the central motion system and physical motion sensors may reside in the tablet while the camera may reside in the dashboard of a car connected via a car wireless network. The main device may be a phone as in item 1004, which may contain the central motion system and the physical sensors. The system may include a pair of earbuds or headphones that may not only detect the sound and pressure in the ear but also relay audio feedback to the user.

The system may also include a pair of wearable goggles or glasses which may communicate with the tablet via wired or wireless technologies that may include Bluetooth, Wi-Fi, cellular or ultra wideband technologies as in item 1007. The system could be deployed in a military aircraft with the central motion system in the display as in item 1005. The central motion system may communicate with a helmet-based device via the aircraft's wired or wireless network. The helmet may not only track the user's head position but also relay back visual guidance to the user via a heads-up display. In some cases the entire system may reside in the vehicle as in item 1006, 1008. The dashboard of a car may include the central motion system, all the physical motion sensors and visual guides that are projected on to the windshield. The camera and other sensors may reside outside of the dashboard but may communicate to the central motion system via a wired or wireless connection that may include Bluetooth, Wi-Fi, cellular, NFC, satellite, vehicle area network, ultra wideband or similar communications technologies. The system may also produce visual feedback via displays in the dashboard to guide the user.

In embodiments the system may reside entirely within a pair of wearable goggles, glasses, immersive headset or other head-worn device 1009. The system may produce either audio feedback through headphones or visual feedback via the display embedded in the wearable headset. The system may include no visual or audio devices at all and may only include motion sensors and physical feedback as in item 1010. In this instance the central motion system and all sensor devices are located on a belt with a vibration system for feedback. The system may also be deployed on a laptop 1011 which may run the central motion system and may include physical motion sensors and may include a camera as well for visual data collection. The feedback may be delivered to the user via visual guides through the laptop monitor or audible guides via the laptop speakers. There may also be configurations where the central motion system resides in a vehicle, while the physical motion sensors may be operating within a wearable like a watch 1012. The vehicle may contain a camera for visual input data collection. The central motion system in this instance may collect data from the watch and camera, then produce audible feedback via the watch over the car network to the watch's audio system which delivers the audible feedback to the user via a pair of headphones. In embodiments, system may adjust for multiple dimensions, such as pitch, roll and yaw, optionally using different input sensor sets to measure motion and/or different output signals, prompts, or the like to compensate for each, in various combinations of the configures disclosed herein. In embodiments, the system may send signals by multiple techniques, such as using both visual and audio prompts, either both for the same adjustment or for separate adjustments (e.g., one prompt to address front to back motion and another to address side-to-side motion). In embodiments, the system may use multiple visual prompts, such as varying font size, font position, and/or flashing/strobing effects in the same device. All of these varying device configurations represent embodiments of the overall system.

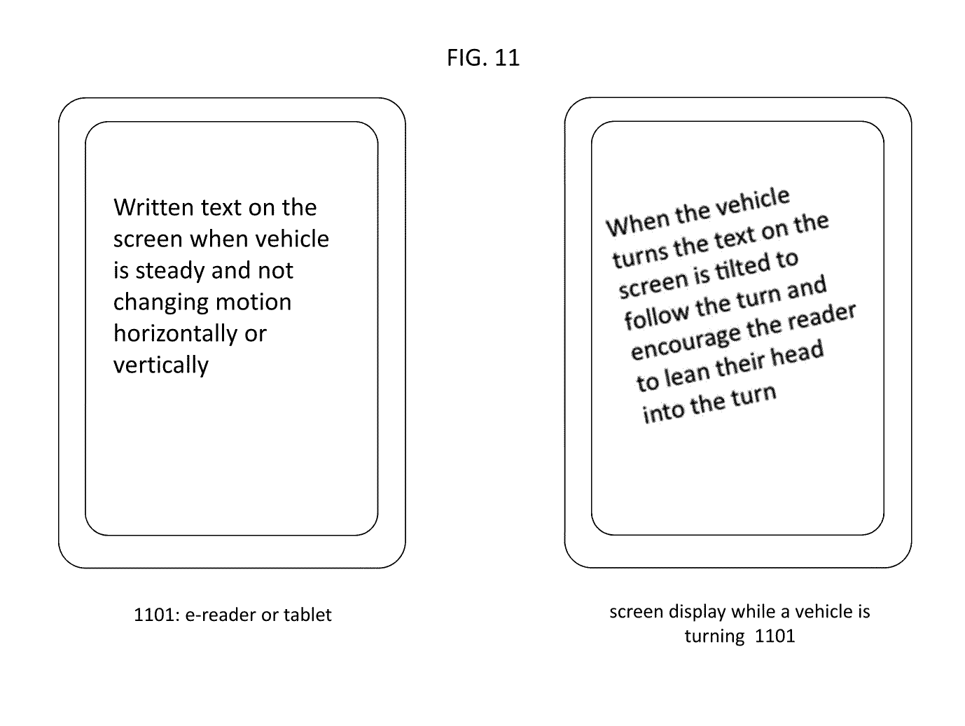

FIGS. 11-20 depict the orientation guides that the central motion system utilizes to deliver the optimal biofeedback data for the particular use case and device configuration. The goal of each orientation guide is to force or encourage the user to maintain proper head orientation versus the gravito-inertial forces they are experiencing in order prevent or delay the onset of motion sickness symptoms. FIG. 11 depicts a visual orientation guide delivered via the screen of an e-reader, tablet, display or phone device 1101. In order to guide the user to optimally orient his or her head along the roll axis, the contents of the screen, whether they encompass text, images or video, will rotate along the roll axis. The user will then tilt the head in the direction of the text in order to view the content easily thus maintaining head balance against the motion forces at that exact moment.

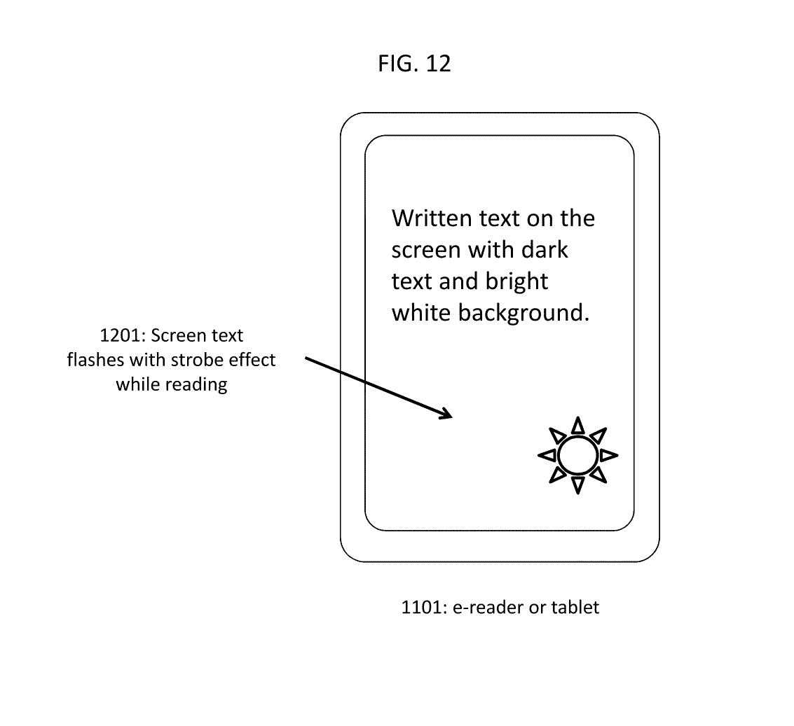

FIG. 12 depicts a feedback model utilizing the strobing technique in order to alleviate retinal slip. The contents of the screen 1201 whether they be text, images or video will strobe or flash on and off at a certain frequency optimized to slow down the perceived movement of the contents. That decrease in movement speed or jitter helps the brain better coordinate its balance system.

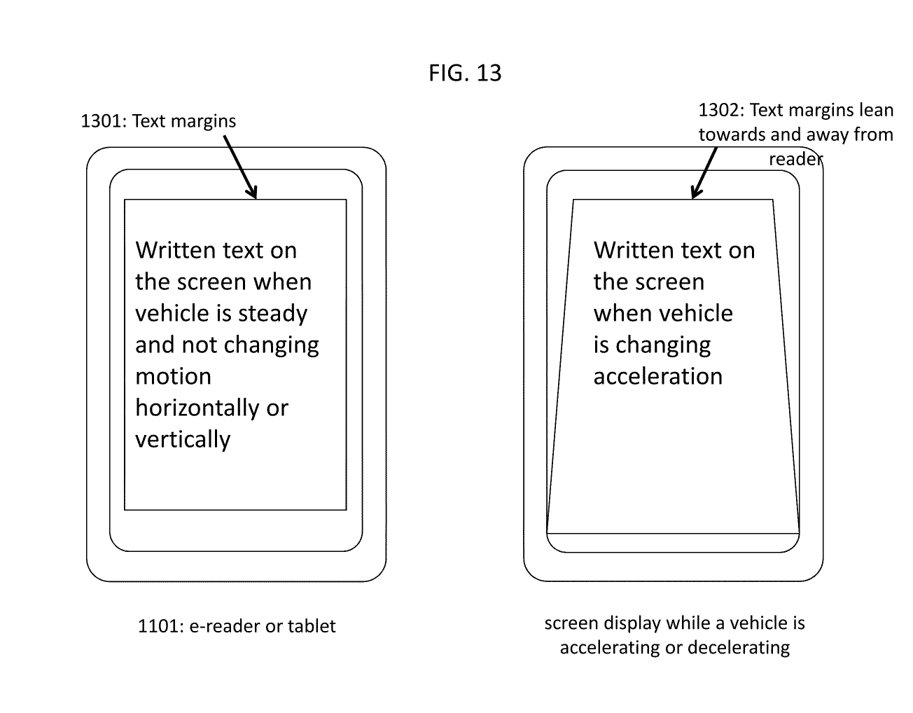

FIG. 13 depicts a visual orientation guide delivered via the screen of an e-reader, tablet, display or phone device 1101. In order to guide the user to optimally orient his or her head along the pitch axis, the contents of the screen 1301, whether they encompass text, images or video, will lean away or towards the user 1302. The user, in response, will lean his or her head forward and backwards to align the head angle to match the contents on the screen thus maintaining head balance against the motion forces at that exact moment.

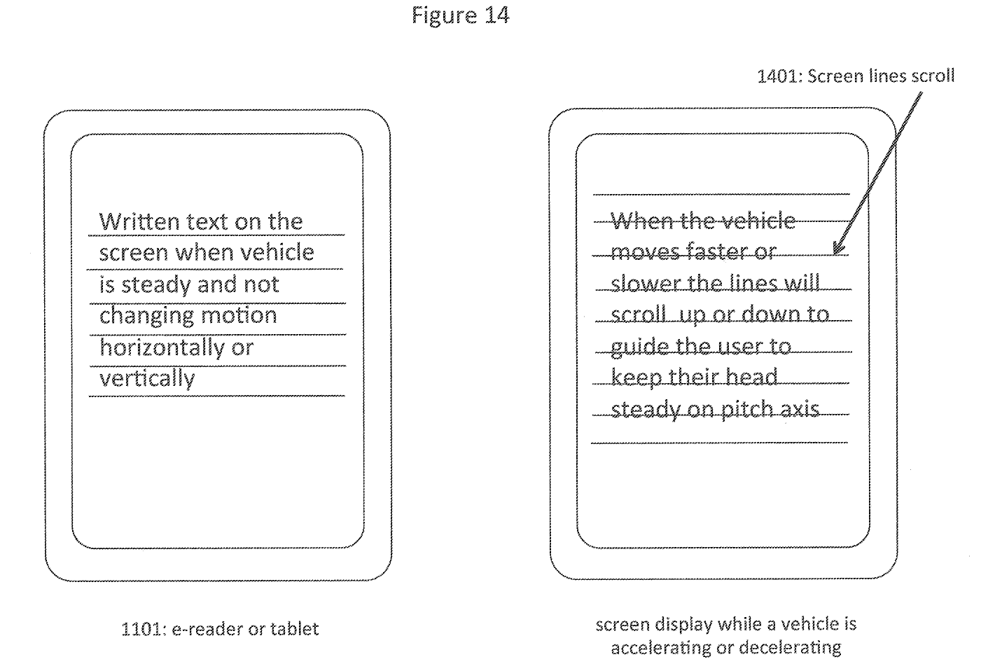

FIG. 14 depicts a visual orientation guide delivered via the screen of an e-reader, tablet, display or phone device 1101. In order to guide the user to optimally orient his or her head along the pitch axis, the display includes subtle guidelines across the content 1401. In order to encourage the user to lean the head backwards, the guidelines will scroll upwards on the screen until the user has leaned the device and his or her head back to the balanced position. In order to encourage the user to lean the head forwards, the guidelines will scroll downwards on the screen until the user leans his or her head forward to the optimal balanced position at which point the lines will return to a steady position. While interacting with the device, the user attempts to keep the lines steady at all times but compensating with head movements along the pitch axis.

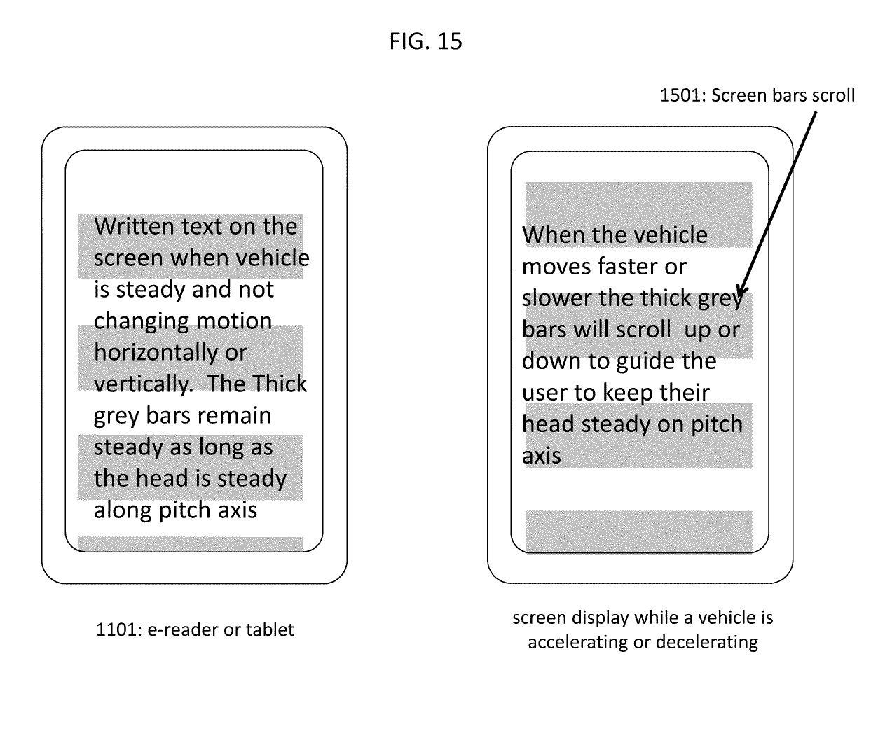

FIG. 15 depicts a visual orientation guide delivered via the screen of an e-reader, tablet, display or phone device 1101. In order to guide the user to optimally orient his or her head along the pitch axis, the display includes subtle screen bars across the content 1501. In order the encourage the user to lean his or her head backwards, the screen bars will scroll upwards on the screen until the user has leaned the device and his or her head back to the balanced position. In order to encourage the user to lean his or her head forward, the screen bars will scroll downwards on the screen until the user leans his or her head forward to the optimal balanced position, at which point the lines will return to a steady position. The thicker bars provide a subtle visual option versus the guidelines depicted in FIG. 14. While interacting with the device, the user attempts to keep the bars steady at all times but compensating with head movements along the pitch axis.

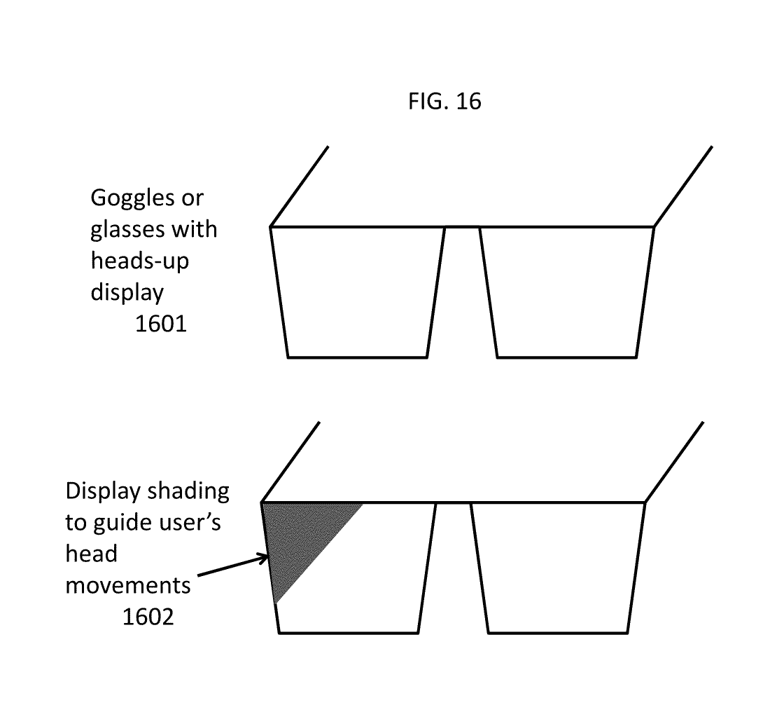

FIG. 16 depicts a device configuration consisting of a wearable technology such as goggles or glasses with a heads-up display 1601. In order to encourage the optimal user head orientation, the heads-up display will become obfuscated in certain areas in order to encourage the user to lean his or her head in the direction of the neutral balance position in order to clear the screen of the obfuscation. For example, in order to guide the user to lean forward and to the left, the heads-up display would color or tint the upper right of the heads-up display 1602. The blockage of the viewable area encourages the user to lean forward and to the left in order to remove the blockage and to see clearly.

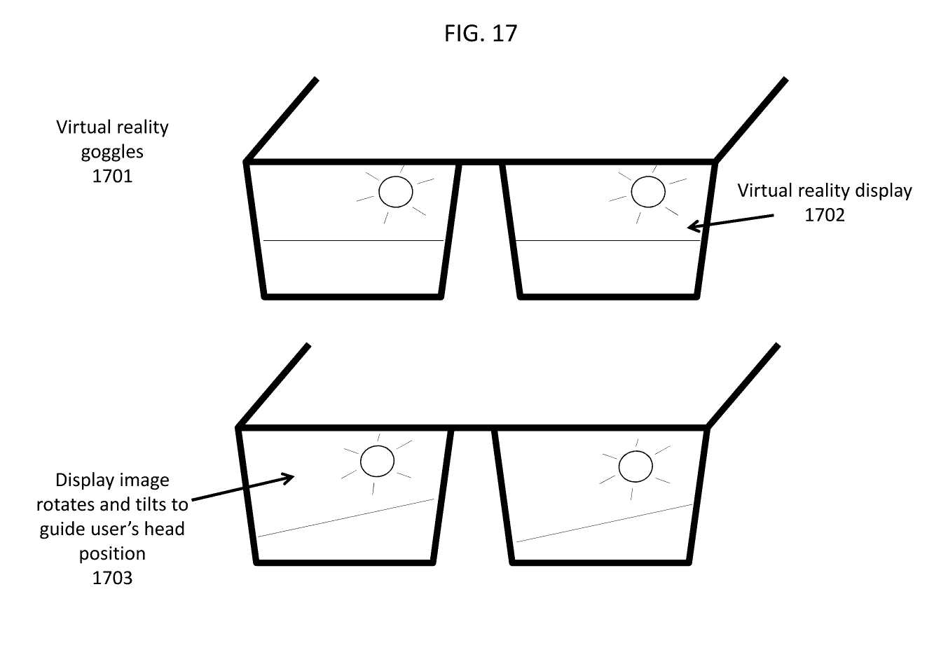

FIG. 17 depicts a device configuration consisting of a wearable technology such as an immersive virtual reality headset 1701 which may include a virtual reality display 1702. Virtual reality headsets have historically struggled in large part because of the motion sickness they induce among large percentage of users. In this configuration the system rotate and tilt the viewable image to encourage the user to lean in the direction of the motion. In a car racing video game example, when the car turns to the left, the viewable image will lean to the left 1703 to encourage the user to lean into the turn thus minimizing the effects of motion sickness, known in this case as simulator sickness.

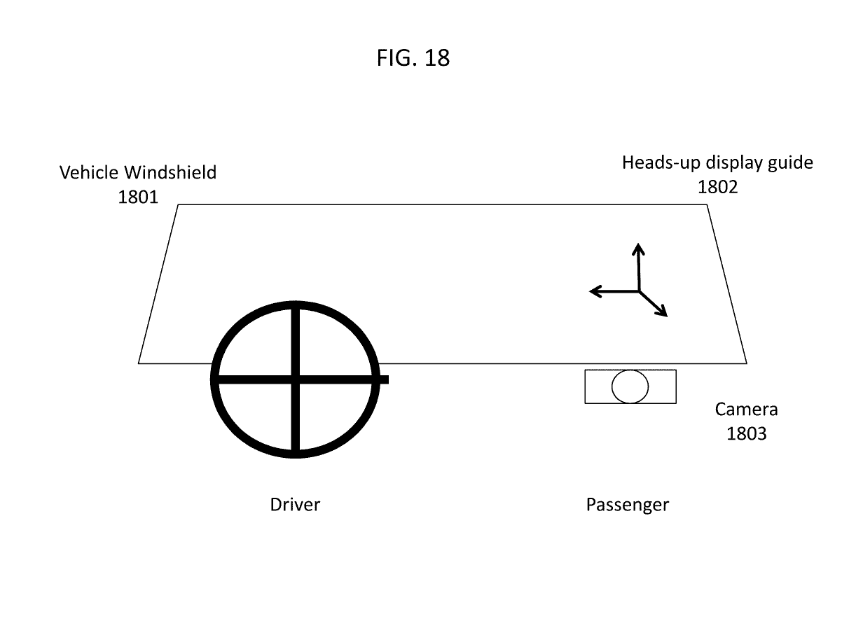

FIG. 18 depicts a device configuration built into a vehicle such as a car. The configuration consists of a heads-up display system built into the vehicle's windshield 1801 and a camera embedded into the dashboard 1803. The camera monitors the user's head position and feeds that information to the central motion system which calibrates the head position with the motion sensors in the system to produce visual guides which are projected onto the windshield. The guides may take the form of a virtual gyroscope 1802 or other form of visual indicator to guide the user to lean his or her head into the motion forces.

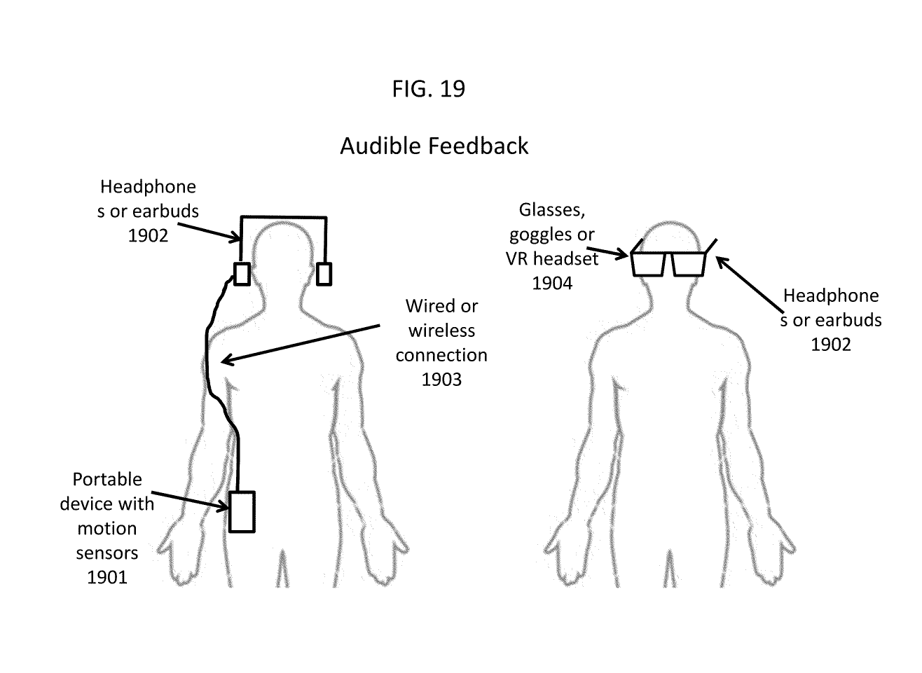

FIG. 19 depicts a number of configuration options that produce feedback via audio rather than visual guides. The user carries a portable device such as a phone or tablet 1901 that includes the motion sensors for the system. The central motion system delivers motion guidance to the user via audio signals sent to the headphones or earbuds 1902 attached to the system with via a wired or wireless connection 1903. In another configuration, the user wears interactive glasses or a VR headset 1904 that includes the motion sensors for the system. The central motion system monitors the head position of the user, and then delivers motion guidance to the user via the headphones or earbuds 1902 of the glasses or headset. Depending on whether the device has stereo speakers (headphones) or a single speaker in the one ear, the system will utilize different audio cues.

For stereo speakers the system will change the pitch, volume and balance depending on the orientation of the user's head in order to guide the user back to steady orientation. The following pattern is one example of how the system will guide users:

Pitch forward=>Increased pitch and volume

Pitch backward=>Decreased pitch and increased volume

Roll left=>Increased volume, balance left

Roll right=>Increased volume, balance right

In more detail, what this pattern means is that when the device pitches forward due to a deceleration of the vehicle or the device determines the user's head position has pitched forward, the device creates a steady tone with increasing pitch and increasing volume to guide the user to lean his or her back to compensate for the changes of forces being felt by the user's body.

For single speaker devices, the system will produce a sound pattern to guide the user along the roll axis since it cannot use balance between left and right speakers. The following pattern is one example of how the system will guide the user:

Pitch forward=>Increased pitch and volume

Pitch backward=>Decreased pitch and increased volume

Roll left=>Increased volume and rapid beating of tone

Roll right=>Increased volume and slow beating of tone

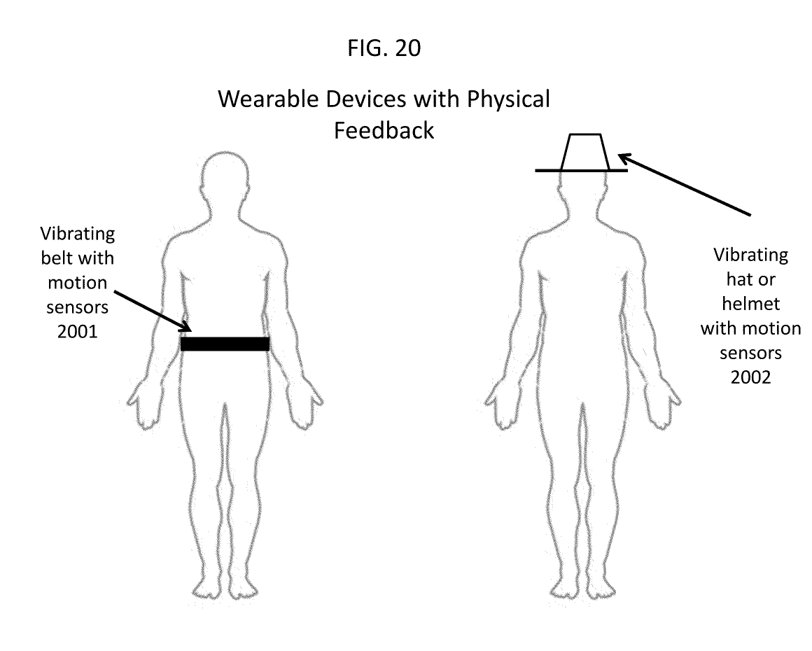

FIG. 20 depicts device configurations for physical feedback mechanisms. A wearable vibrating belt 2001 sends vibrations to different sides of the user's body to guide them to orient his or her entire body as well as the head in the direction of motion to prevent the onset of motion sickness. The belt contains all the sensors, central motion system and the physical orientation guides of the system. Object 2002 depicts an alternative configuration showing the system encapsulated in other wearable objects such as a hat. The pulses or vibrations emitted by these configurations are the guides that help a user avoid motion sickness.

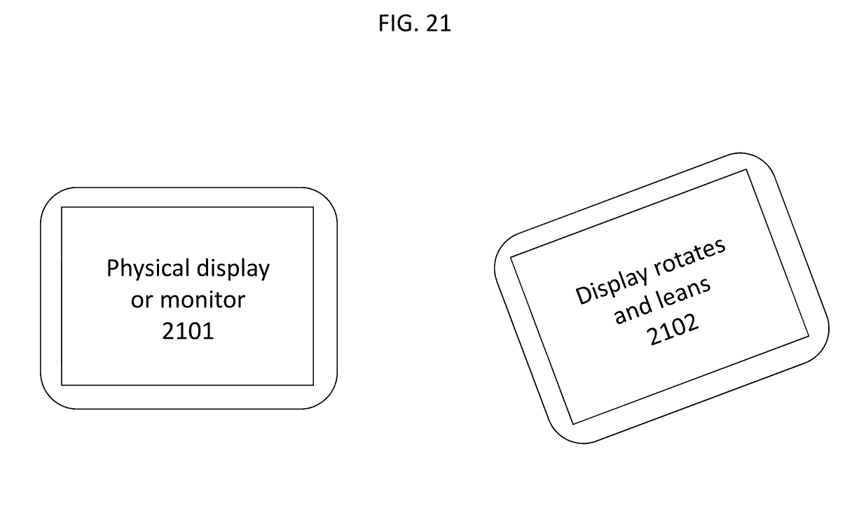

FIG. 21 depicts a physical configuration of the system including a physical monitor or display 2101 in which the display itself rotates and tilts 2102 to guide the user to the optimal head orientation. In use cases where the contents of the screen cannot to be controlled then the actual device itself can be controlled in a way to guide user behavior. Pilots, for example, cannot sacrifice screen space for visual feedback guides therefore the system would guide the user's head position by rotating and tilting the entire physical display or monitor device.

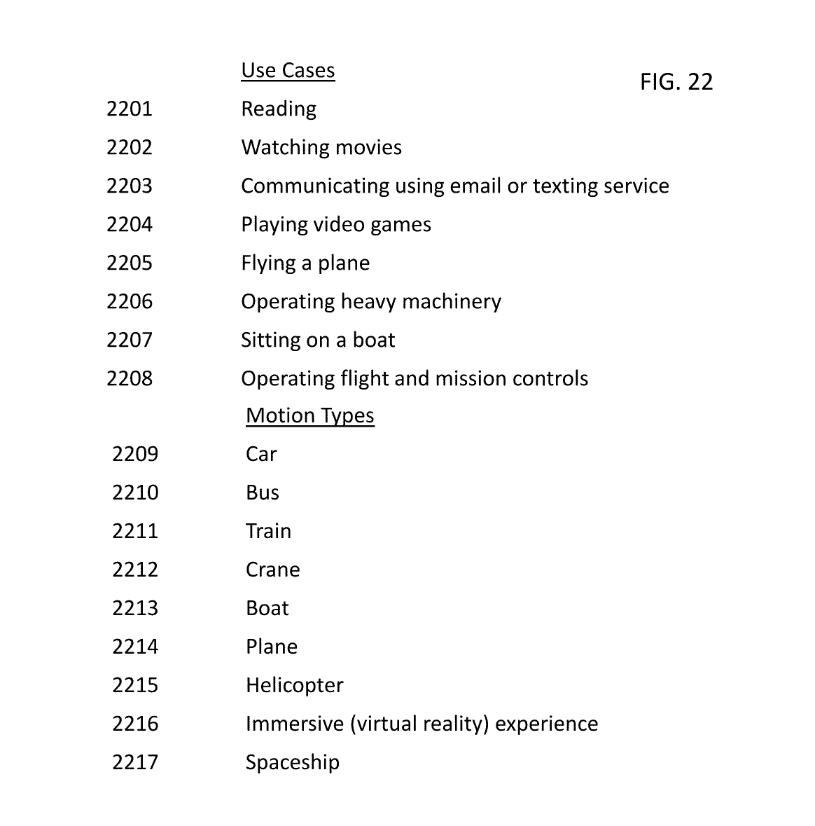

In embodiments, the methods and systems disclosed herein may be used in a variety of environments, having a variety of motion types, and relating to a variety of uses and content types FIG. 22. For example, one such situation involves reading on commuter trains 2201, where relatively gentle but relatively constant horizontal rocking motion is accompanied by less frequent, but very strong acceleration and deceleration in the main direction of motion, with minimal vertical motion. In such a situation, orienting the user to lean forward or backward at the appropriate time, while maintaining a relatively straight head in the side-to-side direction, should ameliorate motion sickness. In another example, the motion situation involves watching a movie 2202 in a car moving at 60 miles per hour where the low wavelength side to side swings from turning that car and the forward and backward motion from stop-and-go traffic cause the visual vestibular disconnect that brings on motion sickness symptoms. Since the user primarily views the inside of the vehicle which is not moving relative to them, orienting the user to lean forward or backward at the appropriate time, while maintaining a relatively straight head in the side-to-side direction, should ameliorate motion sickness. In the example of communicating via email while riding a subway 2203, the axis can be switched because many riders sit sideways. So the system needs to adjust the orientation guides to have the user lean the head to the side facing the front of the subway car when the subway accelerates and to the side facing the back of the subway car when the subway brakes. Conversely the system needs to guide the user to lean the head forward when the subway turns in the direction the user is facing and vice versa when the subway turns in the opposite direction that the user is facing. Other applications may include the situations faced by operators of heavy machinery 2206, who may experience motion sickness caused by movements of their equipment.

On a boat 2207, typically the rolling side-to-side motion from the waves is very subtle swinging a mere 2-3 degrees. But depending on the user's position in the boat, that resulting change in the orientation of the gravito-inertial forces can be much higher. The system needs to assess the exact change that the user is experiencing and encourage leaning of the head side to side to match the forces. As the boat enters heavier seas the movements along the pitch axis forward and back become stronger and the user's relative position in the boat once again plays a big role in the degree of change in forces. In fact, on cruise ships the cabins located nearest the boat's center of gravity are the most expensive because they experience the least amount of movement along the various axes. In addition, ocean movement also changes the vertical forces that the user experiencing and the guides need to help the user anticipate the up and down changes in motion as the boat rides the waves. The motion experienced on planes is even more dramatic with movement along every axis. First time pilots 2205, 2208 and on small aircraft will often experience motion sickness because they have to concentrate on the displays inside the cockpit. There often isn't enough extra space on a digital display to provide visual orientation guides to the user so in some cases the displays or monitors themselves will move to guide the user to proper head orientation. While commercial airliners are more steady and fly higher to avoid erratic motion, they still experience turbulence making many passengers nauseas.

The playing of video games 2204 inverts the entire model as the eyes detect dramatic motion changes but the ears and muscles may feel no changes. Newer video games bring incredibly lifelike visuals to car racing and flying games for example. The brain expects to feel the motion it is seeing and gets confused when it does not. The situation is even more dramatic with the usage of virtual reality goggles which block out all other visual elements around the user. To address motion sickness in this scenario, the visual scene needs to be modified to encourage the user to move his or her head along with the motion he or she is seeing in the game. As the video car game turns left, the user needs to lean his or her head left with the virtual motion in order to avoid the onset of motion sickness symptoms.

The present disclosure is useful for countering the effects of many types of motion experienced by people and summarized in FIG. 22. These motion types may include motor-vehicle type motion, including car motion 2209, bus motion 2210, train motion 2211, crane (heavy equipment) motion 2212. Other forms of motion may be faster, such as boat motion 2213, airplane motion 2214, helicopter motion 2215, immersive (virtual reality) experience-related motion 2216 and spaceship motion 2217. The solutions discussed in the present disclosure help to counteract the effects of each of these types of motion.

While the disclosure has been described in connection with certain preferred embodiments, other embodiments would be understood by one of ordinary skill in the art and are encompassed herein.

The methods and systems described herein may be deployed in part or in whole through a machine that executes computer software, program codes, and/or instructions on a processor. The present disclosure may be implemented as a method on the machine, as a system or apparatus as part of or in relation to the machine, or as a computer program product embodied in a computer readable medium executing on one or more of the machines. The processor may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, facilities and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software facilities, or as facilities that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipments, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the disclosure has been disclosed in connection with the preferred embodiments shown and described in detail, various modifications and improvements thereon will become readily apparent to those skilled in the art. Accordingly, the spirit and scope of the present disclosure is not to be limited by the foregoing examples, but is to be understood in the broadest sense allowable by law.

All documents referenced herein are hereby incorporated by reference.

1. A system for reducing motion sickness of a reader, comprising:
a device having a processor and a display for displaying content to a user;
a detection facility for detecting at least one of location, orientation, motion and acceleration of the device; and
a display modification module for modifying the content to induce the user to move in coordination with the detection.

2. A system of claim 1, wherein modifying the content comprises adjusting at least one of the vertical and horizontal position of the display.

3. A system of claim 1, wherein modifying the content comprises adjusting the content position relative to the direction of at least one of gravitational forces and inertial forces.

4. A system of claim 1, wherein modifying content comprises sliding the content on the display in the opposite direction of at least one of gravitational forces and inertial forces as a vehicle turns.

5. A system of claim 1, wherein the detection facility takes input from at least one of at least one accelerometer, at least one pitch sensor, at least one roll sensor, at least one yaw sensor, at least one GPS input, at least one compass, at least one gyroscope, at least one magnetometer, at least one camera, at least one Bluetooth-connected device, at least one WiFi-connected device, and at least one proximity sensor.

6. A system of claim 1, further comprising predicting at least one of the intensity and direction of motion of a vehicle in which the reader is located.

7. A system of claim 6, wherein prediction of at least one of intensity and direction of at least one of motion and acceleration is based on at least one of GPS data, accelerometer information, compass information, gyro information, information from a vehicle steering system, information from a braking system, information from a gas pedal, information from a vehicle-mounted camera, information from a device-mounted camera, information from a head-worn device, and information from a vehicle's engine control unit.

8. A system of claim 1, wherein the device is at least one of a smart glasses device, a cellphone, a smart phone, a tablet computer, a laptop computer, a smart watch, and a wearable device.

9. A system of claim 1, wherein the modification of content is based at least in part on the environment of the device.

10. A system of claim 9, wherein the environment of the device comprises at least one of a car, a bus, a train, a spaceship, a walking environment, a boat, a ship, an airplane, a helicopter, a flying environment, a floating environment, a trolley car, and a subway car.
